(19) United States
(12) Patent Application Publication
(10) Pub. No.: US 2013/0275299 A1
(43) Pub. Date: Oct. 17, 2013

(54) SYSTEM AND METHOD FOR ELECTRONIC RECEIPT MANAGEMENT USING USER TERMINAL

(71) Applicant: SHINSEGAE I&C CO., LTD, Seoul (KR)

(72) Inventors: Yun Ji Yang, Seoul (KR); Moon Kyu Lee, Gyeonggi-do (KR); Kee Beom Cho, Seoul (KR); Sang Hoon Kim, Gyeonggi-do (KR)

(73) Assignee: SHINSEGAE I&C CO., LTD, Seoul (KR)

(21) Appl. No.: 13/759,154

(22) Filed: Feb. 5, 2013

(30) Foreign Application Priority Data
Apr. 17, 2012 (KR) 10-2012-0039558

(51) Int. Cl. G06Q 20/04

(52) U.S. Cl. CPC G06Q 20/0453
USPC 705/41

(57) ABSTRACT

Provided are systems and methods for electronic receipt management using a user terminal which includes an electronic wallet where payment information is stored, an electronic receipt application storing and managing an electronic receipt, an installation number generated to determine what number of application is installed when the electronic receipt application is installed, a dongle including a payment request relay unit requesting an installation number and payment information to the user terminal to transfer received installation number, payment information, and the amount of requested payment to a payment server, a payment unit making a payment using the payment information and the amount of requested payment received from the payment request relay unit and an electronic receipt issuing unit issuing an electronic receipt when the payment unit makes a payment and transferring the issued electronic receipt and the installation number received from the payment request relay unit to an electronic receipt server.

### CROSS-REFERENCE TO RELATED APPLICATIONS

This US non-provisional patent application claims priority under 35 USC §119 to Korean Patent Application No. 10-2012-0039558, filed on Apr. 17, 2012, the entirety of which is hereby incorporated by reference.

### BACKGROUND OF THE INVENTION

The present general inventive concept relates to systems and methods for electronic receipt management using a user terminal

Generally, when there is a business relationship of products or services and assets in daily life, persons receive a paper receipt or confirmation and use the received paper receipt or confirmation as an evidence source of each other.

However, since most receipts are made of paper, there remains a risk of loss of the receipts. Moreover, although receipts are issued after payment, most of the receipts are often thrown away.

In addition, since current receipts are provided with various formats according to receipt publishers, it is difficult for users to systemically manage their consumption.

Furthermore, the amount of stored receipts increases with the lapse of time. Accordingly, a separate receipt storage area is required and it takes a lot of time to find certain receipts. Probability of loss of the receipts also increases. When unnecessary receipts are eliminated, additional care must be taken to prevent leakage of personal information. That is, a lot of attention of consumers is required to cause inconvenience to the users.

The steps of receiving a receipt are complex. More specifically, when a user pays for a purchase at the counter after choosing products, the user gives a clerk a payment card and a membership card or a point card and the clerk makes a payment using the cards. And then, if the payment is made, the user receives the cards and a receipt, which is issued when the user is signed, from the clerk. As above, it is inconvenient for the user to confirm and receive the receipt as well as check and manage the receipt at a later date.

### SUMMARY OF THE INVENTION

Embodiments of the inventive concept provide a system and a method for electronic receipt management using a user terminal

According to an aspect of the inventive concept, a system for electronic receipt management using a user terminal may include a user terminal including an electronic wallet in which payment information is stored, an electronic receipt application storing and managing an electronic receipt, and an installation number generated to determine what number of application is installed when the electronic receipt application is installed; a dongle including a payment request relay unit requesting an installation number and payment information to the user terminal to transfer received installation number, payment information, and the amount of requested payment to a payment server; the payment server including a payment unit making a payment using the payment information and the amount of requested payment received from the payment request relay unit and an electronic receipt issuing unit issuing an electronic receipt when the payment unit makes a payment and transferring the issued electronic receipt and the installation number received from the payment request relay unit to an electronic receipt server; the electronic receipt server including database receiving and pre-storing a serial number and an installation number of the user terminal when the installation number of the user terminal is generated and storing the electronic receipt received from the electronic receipt issuing unit and a search unit searching a serial number of a user terminal where the installation number of the user terminal received from the electronic receipt issuing unit matches an installation number pre-stored in the database and transferring the searched serial number of the user terminal to a push server; and the push server receiving a push signal to execute a push alarm notifying an electronic receipt application of a user terminal corresponding to a serial number of a user terminal received from the search unit that an electronic receipt is issued. The electronic receipt may include a simple receipt and a complete receipt containing detail information of the simple receipt. The payment server may issue the simple receipt and the complete receipt and transfer the simple receipt and the complete receipt to the electronic receipt server. The simple receipt may contain payment date, payment items, and the content of the amount of requested payment. The complete receipt may contain the content and detailed history of the simple receipt. The user terminal may generate the next installation number of a finally granted installation number when the electronic receipt application is deleted and re-installed and re-transfers the next installation number and a serial number to database of the electronic receipt server, and the database of the electronic receipt server may re-store the re-transferred installation number and serial number. When one user possesses a plurality of user terminals, serial numbers of the user terminals may be all different from each other while the user terminals include the same payment information and installation numbers are granted in the order of installing an electronic receipt application on the user terminals. The electronic receipt application may be executed to display the simple receipt, request a complete receipt corresponding to a simple receipt to the electronic receipt server when a user selects one of the items of the simple receipt, receive and store the requested complete receipt, and display a complete receipt corresponding to a simple receipt selected among stored complete receipts.

In an exemplary embodiment, a push alarm may be executed to the electronic receipt application when the user terminal receives a push signal from the push server.

In an exemplary embodiment, the user terminal may further include a communication unit requesting an electronic receipt to the electronic receipt server when the push alarm is confirmed and receives an electronic receipt transferred from the electronic receipt server according to the request in the manner of wireless internet.

According to another aspect of the inventive concept, a method for electronic receipt management using a user terminal may include (a) a contact step in which a user terminal comes in contact with a dongle within a certain distance; (b) a payment request relay step in which the dongle transfers an installation number, payment information, and the amount of requested payment received by requesting an installation number and payment information to the user terminal to a payment server; (c) a step in which the payment server makes a payment using the payment information and the amount of requested payment received from the dongle, issues an electronic receipt after making a payment, and transfers the issued electronic receipt and the installation number received from the dongle to an electronic receipt server; (d) a step in which the electronic receipt server stores the electronic receipt received from the payment server, searches a serial number of a user terminal where the installation number received from the payment server matches an installation number pre-stored in database, and transfers the searched serial number of the user terminal to a push server; and (e) a step in which when the serial number of the user terminal is received from the electronic receipt server, the push server transmits a push signal to execute a push alarm notifying an electric receipt application of a user terminal corresponding to the received serial number of the user terminal that an electronic receipt is issued. The electronic receipt may include a simple receipt and a complete receipt containing detail information of the simple receipt. The step (d) may be characterized in that the payment server issues the simple receipt and the complete receipt and transfers the simple receipt and the complete receipt to the electronic receipt server. The simple receipt may contain payment date, payment items, and the content of the amount of requested payment. The complete receipt may contain the content and detailed history of the simple receipt. Before the step (a), the method may further include a step in which when an electronic receipt application is installed by a user, a user terminal transfers an installation number and a serial number to database of the electronic receipt server and the database stores the transferred installation number and serial number. The user terminal may generate the next installation number of a finally granted installation number when the electronic receipt application is deleted and re-installed and re-transfers the next installation number and a serial number to database of the electronic receipt server, and the database of the electronic receipt server may re-store the re-transferred installation number and serial number. When one user possesses a plurality of user terminals, serial numbers of the user terminals may be all different from each other while the user terminals include the same payment information and installation numbers are granted in the order of installing an electronic receipt application on the user terminals. The electronic receipt application may be executed to display the simple receipt, request a complete receipt corresponding to a simple receipt to the electronic receipt server when a user selects one of the items of the simple receipt, receive and store the requested complete receipt, and display a complete receipt corresponding to a simple receipt selected among stored complete receipts.

In an exemplary embodiment, the method may further include (f) a step in which the user terminal makes a push alarm executed to the electronic receipt application when a push signal is received from the push server.

In an exemplary embodiment, the method may further include (g) a step in which a communication unit requests an electronic receipt to the electronic receipt server when the push alarm is confirmed and receives an electronic receipt transferred from the electronic receipt server according to the request in the manner of wireless internet.

### BRIEF DESCRIPTION OF THE DRAWINGS

The inventive concept will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the inventive concept.

FIG. 1 is a configuration diagram of a system for electronic receipt management using a user terminal according to an embodiment of the inventive concept.

FIG. 2 is a procedure diagram illustrating a system and a method for electronic receipt management using a user terminal according to an embodiment of the inventive concept.

FIGS. 3 and 4 are flowcharts illustrating a method for electronic receipt management using a user terminal according to an embodiment of the inventive concept.

FIG. 5 shows an electronic receipt of a system and a method for electronic receipt management using a user terminal according to an embodiment of the present invention.

### DETAILED DESCRIPTION

The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose examples of the inventive concept and to let those skilled in the art understand the nature of the inventive concept. Like reference numerals refer to like elements throughout.

Hereinafter, the inventive concept will now be described with reference to accompanying drawing illustrating a system and a method for electronic receipt management using a user terminal according to embodiments of the inventive concept.

A system for an electronic receipt management using a user terminal according to an embodiment of the inventive concept includes a user terminal, a dongle, a payment server, an electronic receipt server, and a push server.

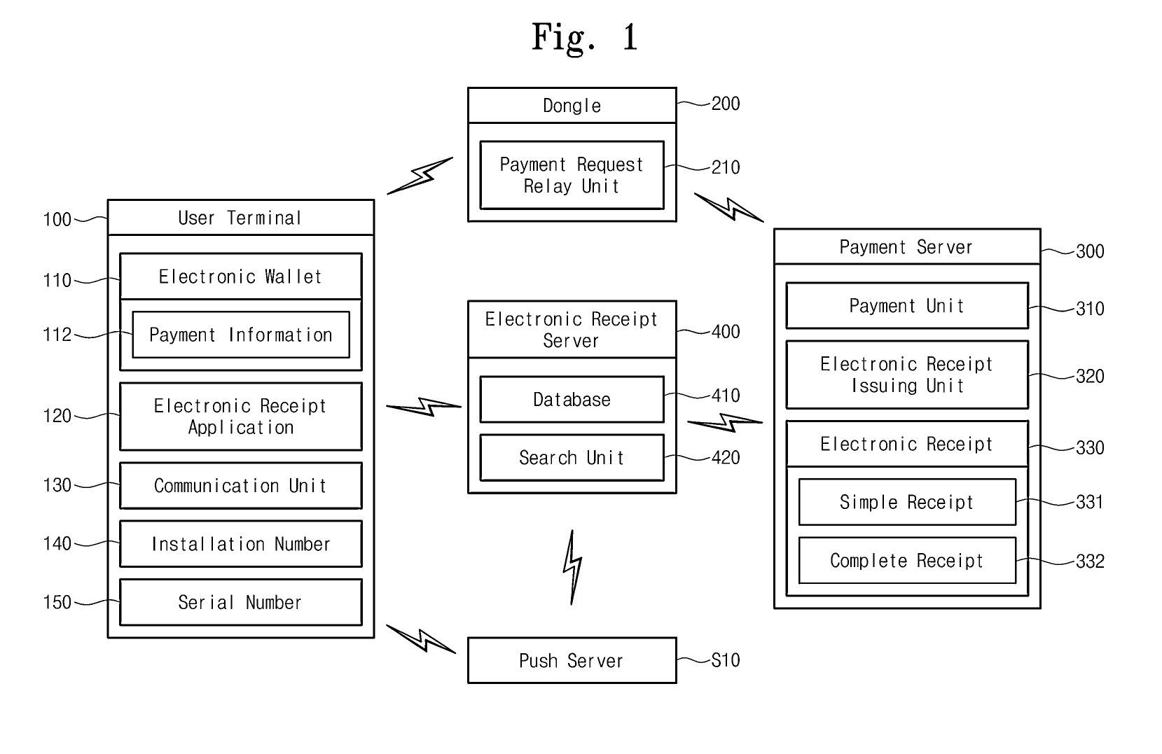

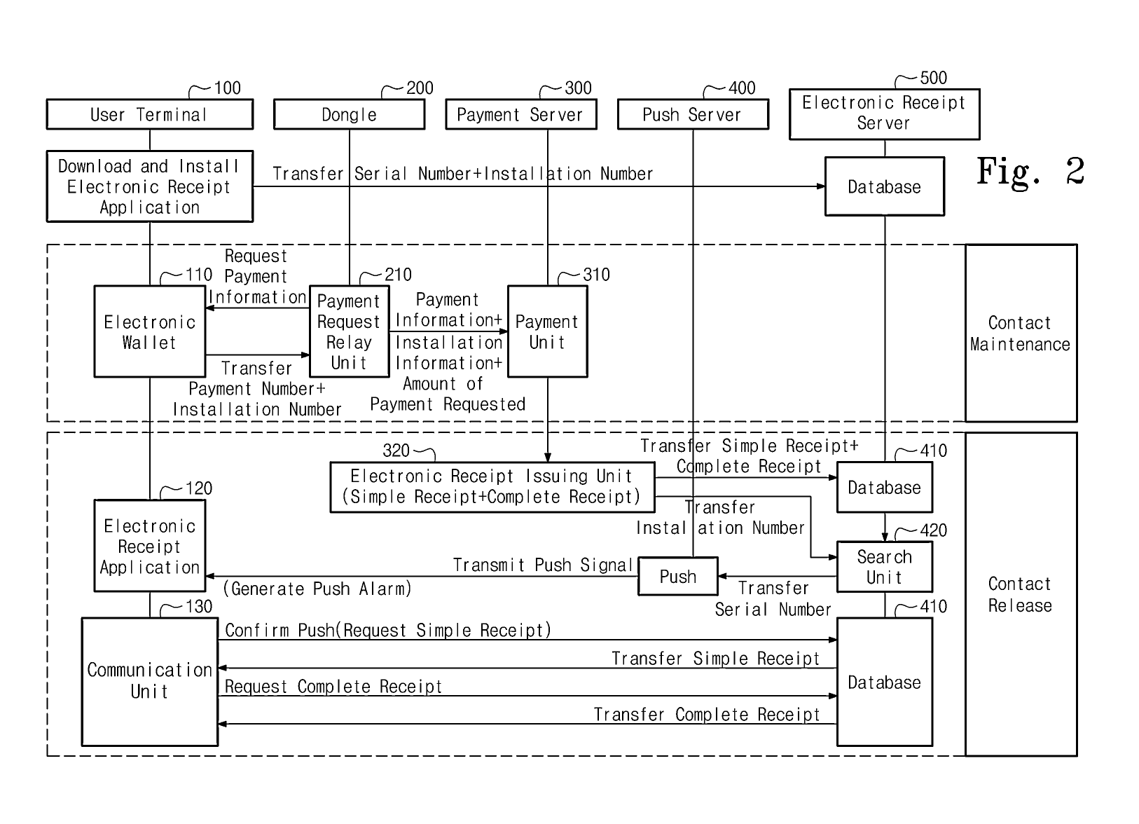

FIG. 1 is a configuration diagram of a system for electronic receipt management using a user terminal according to an embodiment of the inventive concept, and FIG. 2 is a procedure diagram illustrating a system and a method for electronic receipt management using a user terminal according to an embodiment of the inventive concept.

Referring to FIGS. 1 and 2, a user terminal 100 includes an electronic wallet 110, an electronic receipt application 120, a communication unit 130, an installation number 140, and a serial number 150.

The electronic wallet 110 stores payment information 112 therein and transmits the payment information 112 to a payment request relay unit 210 when the payment information 112 is requested from the payment request relay unit 210 of a dongle 200 that will be described later.

The electronic wallet 110 is a kind of electronic payment system for use in electronic commerce (e-commerce). Unlike a smart card that is an IC-type electronic money (e-money), the electronic wallet 110 is software that is capable of paying the price for electronic commerce (e-commerce) while storing a currency value in a hard disk of a personal computer (PC) or a virtual bank account to be used like a wallet.

Since the payment information 112 includes personal information for payment or information on a point card, points may be earned and used when the payment is done by a payment unit 310 that will be described later.

The electronic receipt application 120 stores and manages the electronic receipt 330. That is, the electronic receipt application 120 is a program that is downloaded and installed on the user terminal 100 to store the electronic receipt 330 received from database 410 of the electronic receipt server 400 by the user terminal 100 and allow a user to confirm and manage a plurality of stored electronic receipts 330.

The electronic receipt 330 includes a simple receipt 331 and a complete receipt 332.

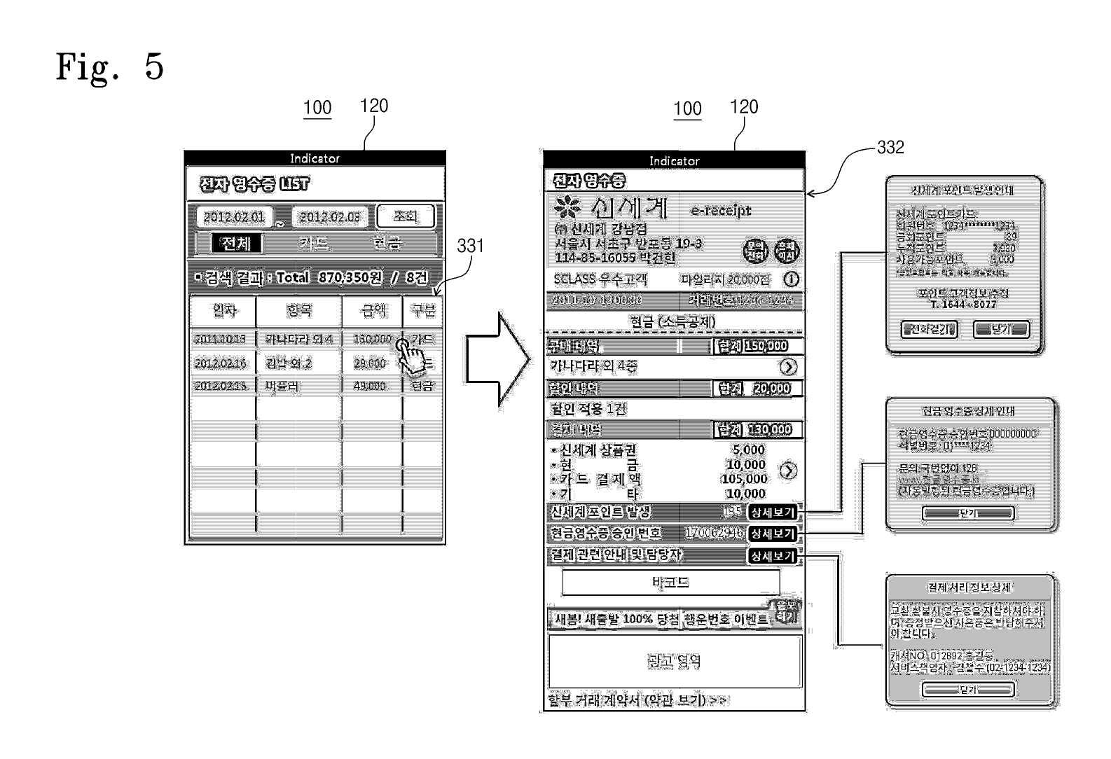

FIG. 5 shows an electronic receipt of a system and a method for electronic receipt management using a user terminal according to an embodiment of the present invention.

Referring to FIG. 5, a simple receipt 331 is a receipt on which payment details are simply marked. Payment date, payment items, and payment amount, etc.

may be marked on the simple receipt 331.

The complete receipt 332 includes detailed information of the simple receipt 331, i.e., details based on the content and payment of the simple receipt 331.

That is, the simple receipt 331 is displayed when the electronic receipt application 120 is executed, and the complete receipt 332 is displayed when a user selects one item in the simple receipt 331. In addition, the detailed content is displayed when the user selects the detailed view on the complete receipt 332.

The user terminal 100 may make a push alarm executed on the electronic receipt application 120 when a push signal is received from the push server 500.

When the user confirms the push alarm executed on the electronic receipt application 120, the user request the electronic receipt 330 to the electronic receipt server 400 and receives the electronic receipt 330 transferred from the electronic receipt server 400 in the manner of wireless internet.

Here, when the user confirms the push alarm, the communication unit 130 requests the simple receipt 331 to the electronic receipt server 400 and receives data on the simple receipt 331 transferred from the electronic receipt server 400 in the manner of wireless internet.

In addition, when the user selects one of the items of the simple receipt 331 displayed by the electronic receipt application 120, the communication unit 130 requests the complete receipt 332 including details on the selected simple receipt 331 to the electronic receipt server 400, and receives the complete receipt 332 transferred from the electronic receipt server 400 in the manner of wireless internet.

The installation number is generated when the electronic receipt application 120 is installed on the user terminal 100 and indicate s how many the electronic receipt application 120 are installed on the user terminal 100.

For example, when one user possesses a plurality of user terminals 100, if the same electronic receipt application 120 is downloaded and installed on the respective user terminals 100, installation numbers 140 are granted to the user terminals according to the installation order.

When the installation number 140 is generated, it may be mixed with a point card number. In addition, the installation number 140 may be newly generated each time the electronic receipt application 120 is installed.

A plurality of serial numbers are granted to each user terminal 100. The granted number is referred to as the serial number 150.

When the electronic receipt application 120 is downloaded and installed, the user terminal 100 transfers the granted installation number 140 and the granted serial number 150 to database 410 of the electronic receipt server 400 that will be described later. The database 410 of the electronic receipt server 400 stores the transferred installed number 140 and the transferred serial number 150 therein.

When the user deletes and reinstall the electronic receipt application 120 while using the user terminal 100, the user terminal 100 may re-transfer a newly granted installation number 140 and a newly granted serial number 150 to the database 410 of the electronic receipt server 400 and the database 410 of the electronic receipt 330 re-store the re-transferred installation number 140 and the re-transferred serial number 150.

The dongle 200 includes a payment request relay unit 210.

The payment request relay unit 210 requests the installation number 140 and the payment information 112 to the user terminal 100 and transfers a received installation number 140, received payment information 112, and the received amount of requested payment to the payment server 300.

The amount of requested payment means the amount of money that a user has to pay when the user purchases a product. The amount of requested payment is the amount of money that is input by a payment terminal (not shown) connected to the dongle 200 to input the amount of paid money.

The dongle 200 may be replaced with a scanner, a cashier number input device or the like. In addition, the dongle 200 may be a plurality of other input means. That is, embodiments of the inventive concept are not limited to the dongle 200 and may adopt a device capable of receiving a request of payment information and payment information based on the request and transferring the received payment information to the payment server 300.

The payment server 300 includes a payment unit 310 and an electronic receipt issuing unit 320.

The payment unit 310 makes a payment using the payment information 112 received from the payment request relay unit 210 and the amount of requested payment. In this case, points may be earned using point card information included in the payment information 112.

The electronic receipt issuing unit 320 issues the electronic receipt 330 when the payment is made at the payment unit 310 and transfers the issued electronic receipt 330 and the installation number received from the payment request relay unit 210 to the electronic receipt server 400.

The electronic receipt 330 issued by the electronic receipt issuing unit 320 includes a simple receipt 331 and a complete receipt 332. The electronic receipt issuing unit 320 transfers the simple receipt 331 and the complete receipt 332 to the electronic receipt server 400.

The electronic receipt server 400 includes database 410 and a search unit 420.

The database 410 receives and pre-stores the serial number 150 and the installation number 450 of the user terminal 100 when the installation number 150 of the user terminal 100 is generated.

In addition, the database 410 stores the electronic receipt 330, i.e., the simple receipt 331 and the complete receipt 332 received from the electronic receipt issuing unit 320.

The search unit 420 searches an installation number 150 of the user terminal 100 where the installation number 140 received from the electronic receipt issuing unit 320 matches the installation number 140 pre-stored in the database 410 and transfers the searched installation number 150 of the user terminal 100 to the push server 500.

For example, as shown in the table (1) attached below, one user possesses three user terminals 100, serial numbers 150 of the respective user terminals are different from each other, and an installation number 140 generated while installing an electronic receipt application 120 is granted to the user terminal 100. At this point, the user terminals 100 include the same payment information 112.

That is, as shown in the table (1), a serial number 150 and an installation number 140 of the user terminal 100 are stored in the database 410. The search unit 420 analyses whether there is a user terminal 100 in which an installation number 140 (‘2’) received from the electronic receipt issuing unit 320 matches an installation number stored in the database 410. If there is the matching installation number 140 (‘2’), the search unit 100 searches an installation number 150 (‘12345’) of the user terminal 100 corresponding to the matching installation number 140 (‘2’).

TABLE (1)

| | | Installation | |
|---|---|---|---|
| User Terminal | Serial Number | Number | Payment Information |
| Terminal 1 | 12345 | 2 | same in all the terminals |
| Terminal 2 | 12346 | 1 | |
| Terminal 3 | 12347 | 3 | |

The search unit 420 transfers the searched serial number 150 (‘12345’) of the user terminal 100 to the push server 500.

The push server 500 transmits a push signal to execute a push alarm when the serial number 150 of the user terminal 100 is received from the search unit 420. The push alarm notifies the electronic receipt application 120 of the user terminal 100 corresponding to the received installation number 150 of the user terminal 100 that the electronic receipt 330 is generated.

Thus, the push alarm enables the user to confirm that the electronic receipt 330 is issued without sharing the serial number 150 of the user terminal 100 with the payment server 300 and the push server 500.

In the above-described system for electronic receipt management using a user terminal according to the inventive concept, only user's personal information for payment is provided to the payment server 300 by using an installation number 140 generated to determine what number of application is installed when an electronic receipt application 120 is installed on a user terminal 100. Without leakage of the other personal information, a push alarm notifying payment and generation of the electronic receipt 330 may be executed and the electronic receipt may be received from the electronic receipt server 400 to maximally prevent leakage of personal information.

Referring to FIG. 2, payment can be made only when the user terminal 100 and the dongle 200 are in contact with each other. In particular, the user terminal 100 and the dongle 200 may be in contact with each other only for a time of requesting and receiving the payment information. Afterwards, their contact may be released. And then, if a push alarm is generated at the user terminal 100 and the user confirms the push alarm, the communication unit 130 requests the simple receipt 331 to the electronic receipt server 400 and receives the simple receipt 331 in the manner of wireless internet. Moreover, since a complete receipt 332 may be received from the electronic receipt server 400 to confirm the complete receipt 332, the complete receipt 332 may be confirmed at any time even when the contact of the user terminal 100 and the dongle 200 is released.

Hereinafter, a method for electronic receipt management using a user terminal according to the inventive concept will now be described more fully with reference to accompanying drawings.

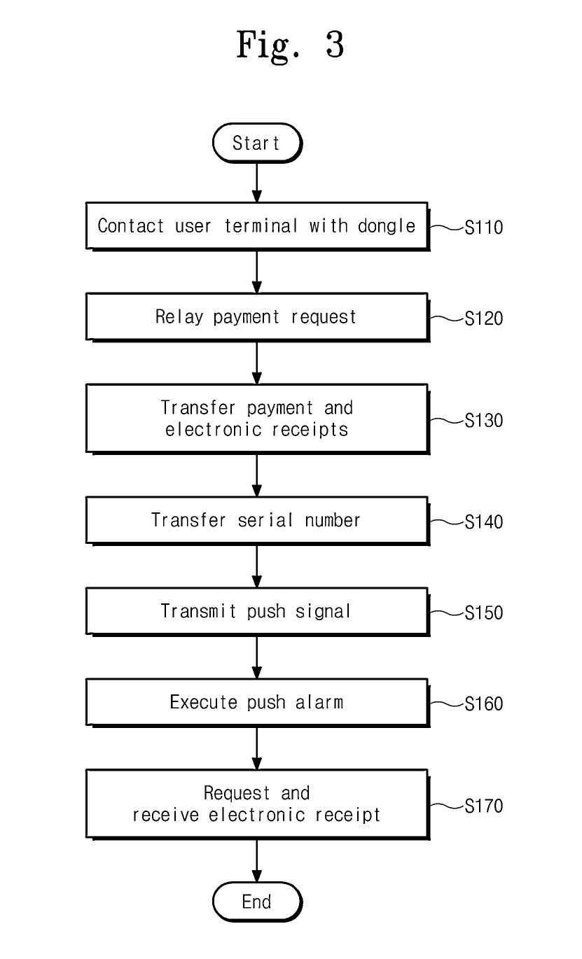

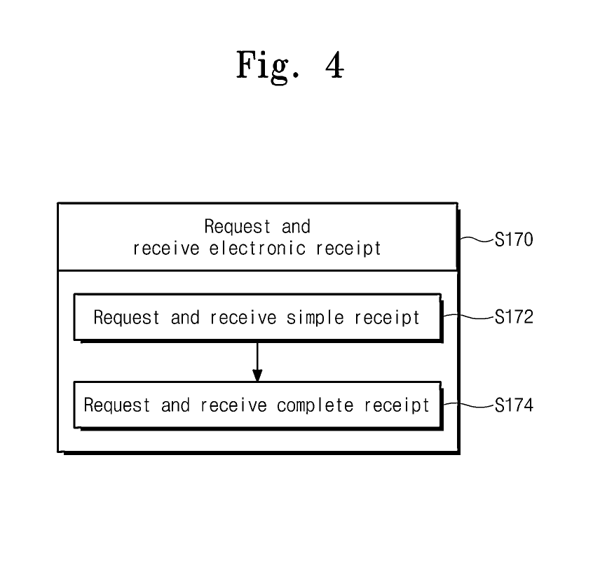

FIGS. 3 and 4 are flowcharts illustrating a method for electronic receipt management using a user terminal according to an embodiment of the inventive concept.

Referring to FIGS. 2 to 4, when a user wants to make a payment, the user terminal 100 comes in contact with the dongle 200 within a certain distance by the user (S110).

In this case, the electronic receipt application 120 may be pre-installed on the user terminal 100.

If the electronic receipt application 120 is installed by the user, the user terminal 100 may transfer an installation number 140 and a serial number 150 to the electronic receipt server 400 and the database 410 of the electronic receipt server 400 may store the transferred installation number 140 and the transferred serial number 150.

The payment request relay unit 210 requests the installation umber 140 and the payment information 112 to the user terminal 100 to receive an installation number 140, payment information 112, and the amount of requested payment. The dongle 200 transfers the installation number 140, the payment information 112, and the amount of requested payment to the payment server 300 (S120).

When the payment unit 310 makes a payment using the payment information 112 and the amount of requested payment received from the payment request relay unit 210, the electronic receipt issuing unit 320 issues an electronic receipt 330 and the payment server 300 transfers the issued electronic receipt 330 and the installation number 140 received from the payment request relay unit 210 to the electronic receipt server 400 (S130).

When issuing the electronic receipt 330, the electronic receipt issuing unit 320 issues a simple receipt 331 and a complete receipt 332.

The simple receipt 331 is characterized to contain the payment date, payment items, and the content of the amount of requested payment. The complete receipt 331 is characterized to contain the detailed contents and items of the simple receipt 331 and details.

In the electronic receipt server 400, the database 410 stores the electronic receipt 330 received from the electronic receipt issuing unit 320, and the search unit 420 searches a serial number 150 of the user terminal 100 where an installation number 140 received from the electronic receipt issuing unit 320 matches an installation number 140 pre-stored in the database 410 and transmits the searched serial number 150 of the user terminal 100 to the push server 500 (S140).

When the serial number 150 of the user terminal 100 is received from the search unit 420, the push server 500 receives a push signal to execute a push alarm which notifies the electronic receipt application 120 of the user terminal 100 corresponding to the received serial number of the user terminal 100 that the electronic receipt 330 is issued (S150).

When the user terminal 100 receives the push signal from the push server 500, the push alarm is executed to the electronic receipt application 120 (S160).

When the push alarm is confirmed, the communication unit 130 requests the electronic receipt 330 to the electronic receipt server 400 and receives the electronic receipt 330 transferred from the electronic receipt server 400 according to the request in the manner of wireless internet (S170).

Referring to FIGS. 2 to 4, when the push alarm is confirmed by the user, the communication unit 130 requests the simple receipt 331 to the electronic receipt server 400 and receives the simple receipt transferred from the electronic receipt server 400 in the manner of wireless internet (S171).

When the user selects one of a plurality of items of the simple receipt 331 displayed by the electronic receipt application 120, the communication unit 130 requests a complete receipt 332 containing a detail of the selected simple receipt 331 to the electronic receipt server 400 and receives a complete receipt 332 transferred from the electronic receipt server 400 according to the request in the manner of wireless internet (S172).

According to a system and a method for electronic receipt management using a user terminal described so far, when a payment is made by contacting a user terminal with a dongle and a push alarm of a push server is confirmed, a simple receipt is received in the manner of wireless internet to confirm payment history using an electronic receipt application. When confirmation of a complete receipt is requested, the complete receipt is received from an electronic receipt server in the manner of wireless internet to easily confirm the details of payment. In addition, a plurality of electronic receipts are systemically stored and easily managed through an electronic receipt application storing and managing a simple receipt and a complete receipt.

In addition, only user's personal information for payment is provided to a payment server by using an installation number generated to determine what number of application is installed when an electronic receipt application is installed on the user terminal A push alarm can be executed to notify payment and issue of an electronic receipt without leakage of the other personal information. Moreover, the electronic receipt is received from the electronic receipt server and thus leakage of personal information can be maximally suppressed.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A system for electronic receipt management using a user terminal, comprising:
a user terminal including an electronic wallet in which payment information is stored, an electronic receipt application storing and managing an electronic receipt, and an installation number generated to determine what number of application is installed when the electronic receipt application is installed;
a payment request relay unit requesting an installation number and payment information to the user terminal and transferring received installation number, payment information, and the amount of requested payment to a payment server;
a payment server including a payment unit making a payment using the payment information and the amount of requested payment received from the payment request relay unit and an electronic receipt issuing unit issuing an electronic receipt when the payment unit makes a payment and transferring the issued electronic receipt and the installation number received from the payment request relay unit to an electronic receipt server;
a electronic receipt server including database receiving and pre-storing a serial number and an installation number of the user terminal when the installation number of the user terminal is generated and storing the electronic receipt received from the electronic receipt issuing unit and a search unit searching a serial number of a user terminal where the installation number of the user terminal received from the electronic receipt issuing unit matches an installation number pre-stored in the database and transferring the searched serial number of the user terminal to a push server; and
a push server transmitting a push signal as such that a push alarm is executed, the push alarm notifying an electronic receipt application corresponding to a serial number of a user terminal received from the search unit that an electronic receipt is issued,
wherein the electronic receipt includes a simple receipt and a complete receipt containing detail information of the simple receipt,
wherein the payment server issues the simple receipt and the complete receipt and transfers the simple receipt and the complete receipt to the electronic receipt server,
wherein the simple receipt contains payment date, payment items, and the amount of requested payment,
wherein the complete receipt contains the content and detailed history of the simple receipt,
wherein the user terminal generates the next installation number of a finally granted installation number when the electronic receipt application is deleted and re-installed and re-transfers the next installation number and a serial number to database of the electronic receipt server, and the database of the electronic receipt server re-stores the re-transferred installation number and serial number,
wherein when one user possesses a plurality of user terminals, serial numbers of the user terminals are all different from each other while the user terminals include the same payment information and installation numbers are granted in the order of installing an electronic receipt application on the user terminals, and
wherein the electronic receipt application is executed to display the simple receipt, requests a complete receipt corresponding to a simple receipt to the electronic receipt server when a user selects one of the items of the simple receipt, receives and stores the requested complete receipt, and displays a complete receipt corresponding to a simple receipt selected among stored complete receipts.

2. The system as set forth in claim 1, wherein a push alarm is executed to the electronic receipt application when the user terminal receives a push signal from the push server.

3. The system as set forth in claim 1, wherein the user terminal further comprises:
a communication unit requesting an electronic receipt to the electronic receipt server when the push alarm is confirmed and receiving an electronic receipt transferred from the electronic receipt server according to the request in the manner of wireless internet.

4. A method for electronic receipt management using a user terminal, comprising:
(a) contacting a user terminal with a dongle within a certain distance;
(b) relaying a payment request wherein the dongle relays an installation number, payment information, and the amount of requested payment from the user terminal to a payment server;
(c) making a payment using the payment information and the amount of requested payment received from the dongle;
(d) issuing an electronic receipt after making a payment;
(e) transfering the issued electronic receipt and the installation number received from the dongle to an electronic receipt server;
(f) storing the electronic receipt received from the payment server;
(g) searching a serial number of a user terminal where the installation number received from a payment server matches an installation number pre-stored in a database;
(h) transferring the searched serial number of the user terminal to a push server; and
(i) receiving the serial number of the user terminal from the electronic receipt server, and transmitting a push signal to execute a push alarm notifying an electric receipt application of a user terminal corresponding to the received serial number of the user terminal that an electronic receipt is issued,
wherein the electronic receipt includes a simple receipt and a complete receipt containing detail information of the simple receipt,
wherein, in the storing step, the payment server issues the simple receipt and the complete receipt and transfers the simple receipt and the complete receipt to the electronic receipt server,
wherein the simple receipt contains payment date, payment items, and the amount of requested payment,
wherein the complete receipt contains the content and detailed history of the simple receipt,
wherein, prior to the contacting step, the method further comprises:
installing an electronic receipt application by a user, transferring an installation number and a serial number to a database of the electronic receipt server and storing the transferred installation number and serial number,
wherein the user terminal generates a next installation number of a finally granted installation number when the electronic receipt application is deleted and re-installed and re-transfers the next installation number and a serial number to the database of the electronic receipt server, and the database of the electronic receipt server re-stores the re-transferred installation number and serial number,
wherein when one user possesses a plurality of user terminals, serial numbers of the user terminals are all different from each other while the user terminals include the same payment information and installation numbers are granted in the order of installing an electronic receipt application on the user terminals, and
wherein the electronic receipt application is executed to display the simple receipt, requests a complete receipt corresponding to a simple receipt to the electronic receipt server when a user selects one of the items of the simple receipt, receives and stores the requested complete receipt, and displays a complete receipt corresponding to a simple receipt selected among stored complete receipts.

5. The method as set forth in claim 4, further comprising:
formulating a push alarm executed to the electronic receipt application when a push signal is received from the push server.

6. The method as set forth in claim 5, further comprising:
requesting an electronic receipt to the electronic receipt server when the push alarm is confirmed; and
receiving an electronic receipt transferred from the electronic receipt server according to the request via wireless internet.
